(19) United States
(12) Patent Application Publication
(10) Pub. No.: US 2005/0092153 A1
(43) Pub. Date: May 5, 2005

(54) Food-slicing machine with one-handed control

(76) Inventor: Fritz Kuchler, Klagenfurt (AT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/979,863

(22) Filed: Nov. 1, 2004

(30) Foreign Application Priority Data
Oct. 31, 2003 (AT) A1731/2003

(51) Int. Cl. B26D 1/14

(52) U.S. Cl. 83/478

(57) ABSTRACT

A machine for slicing a foodstuff has a housing, a blade displaceable on the housing, and a stop plate on the housing adjacent the blade, and displaceable on the housing to control slice thickness. A knob rotatable on the housing is coupled to the stop plate for adjusting slice thickness. A carriage adapted to hold the foodstuff against the plate is displaceable past the blade. A drive can be energized to reciprocate the carriage past the blade and thereby cut a slice from the foodstuff as the carriage moves past the blade. The knob is axially shiftable from a rest position or a separate control ring immediately adjacent the knob is rotationally shiftable from a rest position to initiate a slicing operation.

### FIELD OF THE INVENTION

The present invention relates to a food-slicing machine. More particularly this invention concerns such a machine used to prepare orders of sliced luncheon meat, cheese, and the like.

### BACKGROUND OF THE INVENTION

In preparing an order of cold cuts or the like in a food store, a standard slicing machine is used having a housing, a blade rotatable by a motor on the housing in a plane, and a carriage adapted to hold the sliceable foodstuff and displaceable parallel to the plane past the blade. A stop plate adjacent the blade and parallel to the plane is displaceable perpendicular to the plane to set slice thickness. In addition a pusher on the carriage presses the foodstuff perpendicular to the plane against a front face of the stop plate. Each time the carriage is stroked past the blade, a slice is cut off and normally drops on the back side of the device.

Modern such slicing machines are provided with drives that automatically reciprocate the carriage past the blade, either in a single-slice mode in which the carriage is moved from a home position past the blade to cut off a single slice and then returns to the home position and stops, or in a continuous mode in which it reciprocates back and forth either continuously until intentionally stopped or until a desired number or weight of slices, as determined by a scale under the output table, has been produced. Thus there is a switch for continuous/single-slice mode and an input pad for entering a desired number of slices or output weight. In addition an output table on the back side of the machine can be moved about to form the slices dropping onto it into a selected array, for instance in rows or in a spiral.

Thus the user must do at least the following to make up an order:
1. Turn on the blade motor.
2. Set the desired slice thickness.
3. Select single-slice or continuous mode.
4. Initiate the slicing operation.

The slice thickness is traditionally set by a rotary knob. The other operations are controlled by switches or keypads placed somewhat out of the way so they stay clean. Thus even with an automatic machine, some time is wasted while the machine operator sets slice thickness then moves on to operate the various switches that control and start the other functions.

### OBJECTS OF THE INVENTION

It is therefore an object of the present invention to provide an improved slicing machine.

Another object is the provision of such an improved slicing machine that overcomes the above-given disadvantages, in particular that is particularly easy to set and operate.

### SUMMARY OF THE INVENTION

A machine for slicing a foodstuff has according to the invention a housing, a blade displaceable on the housing in a cutting direction, and a stop plate on the housing having a face extending substantially parallel to the direction, adjacent the blade, and displaceable on the housing transversely of the cutting direction. A knob rotatable about a knob axis on the housing is coupled to the stop plate for positioning the stop plate transversely of the cutting direction and thereby establishing a slice thickness. A carriage adapted to hold the foodstuff against the plate is displaceable generally parallel to the direction on the housing past the blade. A drive can be energized to reciprocate the carriage past the blade and thereby cut a slice from the foodstuff as the carriage moves past the blade. According to the invention the knob is axially shiftable along the knob axis from a rest position or a separate control ring immediately adjacent the knob is rotationally shiftable from a rest position on the housing. A spring urges the knob or control ring into the rest position. A controller including a switch is coupled to the control ring or to the knob for energizing the drive means when the control ring or knob is moved from its rest position.

According to the invention the carriage is displaceable on the housing between an outer position offset from the blade and an inner position at the blade such that a slice is cut from the foodstuff on the carriage on displacement of the carriage from the outer position to the inner position. The controller operates the drive to shift the carriage from the outer position to the inner position and then back into the outer position so long as the control ring is not in the rest position.

The control ring and/or the knob in accordance with the invention is movable from the rest position in opposite angular or axial directions into two end positions. A latch releasably retains the knob or control ring in one of the end positions against the force of the spring so that when it is shifted into and latched in the one end position the drive will be operated continuously while when shifted into the other end position the knob or ring will return automatically to the rest position and the drive will stop on returning to the outer position.

The housing includes a cylindrical or tapered mount centered on the axis and carrying the knob and also, if provided, the ring. This is an extremely convenient construction particularly facilitating one-handed operation of the machine.

According to another feature of the invention a setting element immediately adjacent the knob is connected to the control means for varying a cycle time of the carriage. This cycle time is varied by varying a pause time between succeeding cycles or by varying a displacement speed of the carriage.

In accordance with the invention a motor connected to the blade is energizeable to rotate the blade, and a switch energizes the motor in accordance with a position of the knob or of the control ring.

### BRIEF DESCRIPTION OF THE DRAWING

The above and other objects, features, and advantages will become more readily apparent from the following description, reference being made to the accompanying drawing in which:

FIG. 1 is a partly diagrammatic side view of the slicing machine according to the invention;

FIG. 2 is a large-scale view of the control head of the machine;

FIG. 3 is a section taken along line III-III of FIG. 2; and

FIGS. 4 and 5 are views like FIG. 3 showing the control ring in two opposite end positions.

### SPECIFIC DESCRIPTION

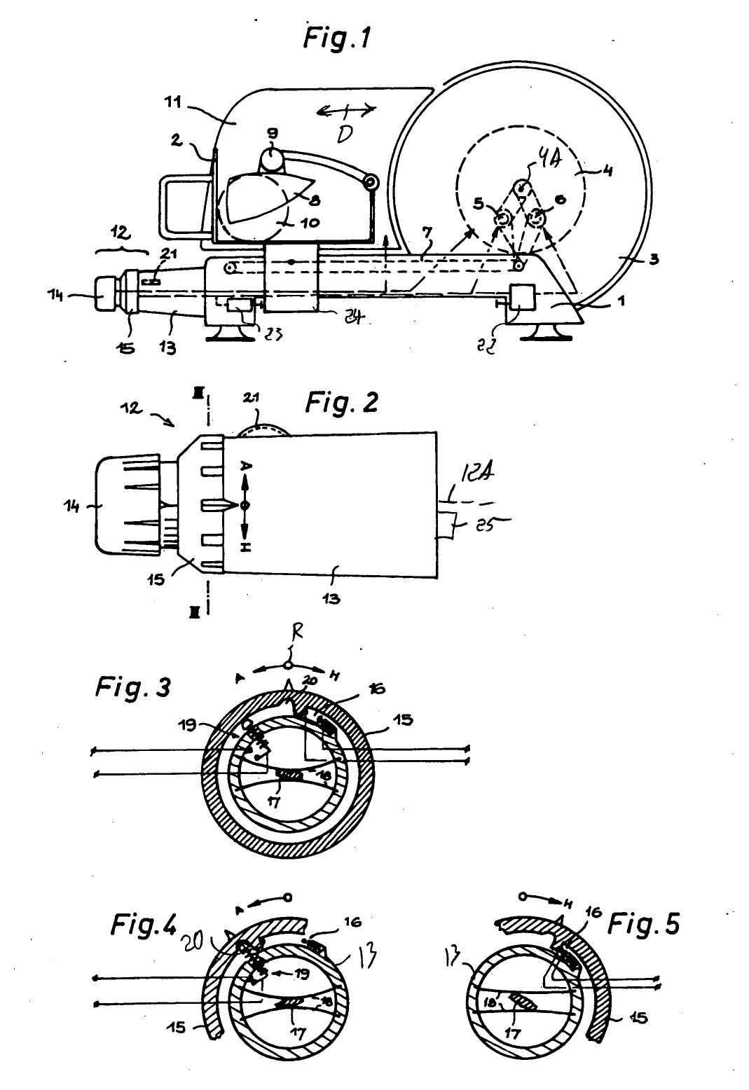

As seen in FIG. 1 a slicing machine according to the invention has a housing 1 normally intended to sit on a counter with a service person standing to the left of the machine as shown in FIG. 1. A carriage 2 is displaceable on the housing 1 in a direction D past a circular blade 3 rotatable by a motor 4 about a horizontal blade axis 4A perpendicular to the direction D and having an edge lying in a vertical plane parallel to the direction D. A stop plate 11 has a face lying in a vertical plane parallel to the blade plane and can as will be described below be shifted limitedly to adjust the spacing between this face and the blade plane so as to vary slice thickness as is well known in the art. A pusher 8 mounted on an arm 9 can press a foodstuff 10 to be sliced, here luncheon meat, against the stop plate 11. As is standard, when the carriage 2 moves from the illustrated outer position offset in the direction D from the blade 3 to an inner position past an edge of the blade 3, a slice is cut from the foodstuff 10 and falls back down on an unillustrated table that can be shifted about to array the slices.

The drive motor 4 is coaxial with the blade 3 and is connected via a pair of belt transmissions 5 and 6, one of which has a crossed belt, to a drive belt 7 connected to the carriage 2. When the transmission 5 is active, typically by energization of an electric clutch, and the transmission 6 is not, with its clutch de-energized and open, the carriage 2 moves inward in the direction D toward the blade 2, and, when the transmission 6 is active and the transmission 5 is not, the carriage 2 moves outward to the illustrated outer position. When neither transmission 5 or 6 is active, the carriage 2 is stationary. A controller 24 has reversing switches 22 and 23 operable by the carriage 2 in the inner and outer positions, respectively, to reverse the carriage 2.

A control head 12 on the housing 1 has a frustoconically tapered body or mount 13 centered on the axis 12A, carrying a standard slice-thickness knob 14 rotatable about an axis 12A, and coupled as is standard to the stop plate 11 to move it horizontally and establish a desired slice thickness. According to the invention a further control ring 15 is mounted on the body 13 and is also limitedly rotatable about the axis 12A from a center rest position R in one direction A for automatic or continuous slicing and in an opposite direction H for cutting a single slice.

The ring 15 is carried on and rotates about the axis 12A with a flattened shaft 17 pinched between a pair of secantal leaf springs 18 that urge the ring 15 into the rest position. When tipped in direction A for continuous slicing as shown in FIG. 4, beveled edges of the shaft 17 spread the springs 18 slightly and urge the ring with relatively low torque back into the rest position R. In addition in the FIG. 4 position, a switch 19 carried on the mount 13 both closes and fits in a latch seat 20 formed in the ring 15 to latch the ring 15 in this position. The motor 4 will be energized and the transmissions 5 and 6 operated alternately by the switches 22 and 23 until the operator rotates the ring 15 back toward the rest position R, overcoming the latching effect of the spring-loaded switch 19. It is also possible for the controller 24 to be provided with an unillustrated alternate input, e.g. a keypad, that allows the user to set a predetermined number of slices or weight at which the carriage 2 will be stopped in the outer home position. The controller 24 can in fact be connected with a shiftable output table or unloading device so that, for instance, fifteen slices can be cut and arrayed in three rows of five slices each.

When tipped in direction H for a single slice as shown in FIG. 5, raised corners of the shaft 17 spread the springs 18 quite a bit more so they urge the ring 15 with a substantially greater torque back into the rest position R. The carriage 2 will be operated when the ring 15 is moved from the rest position R in direction H for single-slice mode for a single cycle from the outer home position to the inner position and back to the home position to cut a single slice from the foodstuff 10. This is done by action on a switch 16 connected, like the switch 19, to the controller 24, but there is no latching of the ring 15.

FIGS. 1 and 2 also show a wheel 21 rotatable in a plane including the axis 12A and connected to the controller 24 so that it can adjust the amount of time the carriage 2 will sit without moving between succeeding cycles. This is useful when the user is operating the machine essentially manually by holding the ring 15 in the single-slice position (direction H) with the right hand while catching the slices in back of the stop plate 11 with his or her left hand, and depositing them manually, as it allows the machine to give the operator enough time to do what needs to be done, e.g. setting the slice on some bread, between succeeding slices. On the other hand, in automatic multiple-slice mode, the machine operates at maximum speed that is normally too fast for a person to keep up with. It is also possible for the wheel 21 to merely set a displacement speed of the carriage 2, so that the cycling is continuous, but variable. Either way the wheel 21 controls the cycle time, either by varying the pause time between succeeding cycles or by varying carriage-displacement speed.

According to another feature of the invention, a start/stop switch 25 (FIG. 2) connected to the controller 24 is provided for starting and stopping the cycling of the carriage is pushed axially. More particularly, when the knob 14 is pulled out, it latches in place, e.g. by means of a spring-loaded ball, and the switch 25 keeps the motor 4 running for multiple-slice operation, while when pushed in it must be held against a spring force to keep the motor 4 running producing only a single slice when not held in.

With the machine according to the invention it is therefore possible to control all the critical functions of the machine with one hand, virtually without moving the hand from a single position at the control head 12. The slice thickness is adjusted in the standard manner by pivoting the knob 14. Single-slice or multiple-slice mode is selected by pivoting the coaxial ring 15 in the direction H or A and/or by pushing in or pulling out the knob. Cycling time for the slicing operation in multiple-slice mode is set by means of the wheel 21.

1. A machine for slicing a foodstuff, the machine comprising:
a housing;
a blade displaceable on the housing in a cutting direction;
a stop plate on the housing having a face extending substantially parallel to the direction, adjacent the blade, and displaceable on the housing transversely of the cutting direction;
means including a knob rotatable about a knob axis on the housing and coupled to the stop plate for positioning the stop plate transversely of the cutting direction and thereby establishing a slice thickness;
a carriage adapted to hold the foodstuff against the plate and displaceable generally parallel to the direction on the housing past the blade;
drive means energizeable for reciprocating the carriage past the blade and thereby cutting a slice from the foodstuff as the carriage moves past the blade;
a control ring closely adjacent the knob and rotatable about the knob axis from a rest position;
a spring urging the control ring angularly of the knob axis into the rest position; and
control means including a switch coupled to the control ring for energizing the drive means when the control ring is moved from its rest position.

2. The slicing machine defined in claim 1 wherein the carriage is displaceable on the housing between an outer position offset from the blade and an inner position at the blade such that a slice is cut from the foodstuff on the carriage on displacement of the carriage from the outer position to the inner position, the control means operating the drive means to shift the carriage from the outer position to the inner position and then back into the outer position so long as the control ring is not in the rest position.

3. The slicing machine defined in claim 1 wherein the control ring is rotatable from the rest position in opposite directions into two end positions, machine further comprising
latch means for releasably retaining the control ring in one of the end positions against the force of the spring, whereby when the control ring is shifted into and latched in the one end position the drive means will be operated continuously while when shifted into the other end position it will return. automatically to the rest position and the carriage will stop on returning to the outer position.

4. The slicing machine defined in claim 1 wherein the housing includes a mount centered on the axis and carrying the knob and ring.

5. The slicing machine defined in claim 1, further comprising
means including a setting element immediately adjacent the knob and connected to the control means for varying a cycle time of the carriage.

6. The slicing machine defined in claim 5 wherein the cycle time is varied by varying a pause time between succeeding cycles.

7. The slicing machine defined in claim 5 wherein the cycle time is varied by varying a displacement speed of the carriage.

8. The slicing machine defined in claim 1, further comprising
a motor connected to the blade and energizeable to rotate the blade; and
switch means for energizing the motor in accordance with a position of the knob.

9. The slicing machine defined in claim 8 wherein the switch means is operated by the knob.

10. The slicing machine defined in claim 8 wherein the switch means is operated by the ring.

11. A machine for slicing a foodstuff, the machine comprising:
a housing;
a blade displaceable on the housing in a cutting direction;
a stop plate on the housing having a face extending substantially parallel to the direction, adjacent the blade, and displaceable on the housing transversely of the cutting direction;
means including a knob rotatable about a knob axis on the housing and coupled to the stop plate for positioning the stop plate transversely of the cutting direction and thereby establishing a slice thickness, the knob being shiftable axially from a rest position;
a carriage adapted to hold the foodstuff against the plate and displaceable generally parallel to the direction on the housing past the blade;
drive means energizeable for reciprocating the carriage past the blade and thereby cutting a slice from the foodstuff as the carriage moves past the blade;
a spring urging the knob into the rest position; and
control means including a switch coupled to the knob for energizing the drive means when the knob is moved from its rest position.

12. The slicing machine defined in claim 11 wherein the carriage is displaceable on the housing between an outer position offset from the blade and an inner position at the blade such that a slice is cut from the foodstuff on the carriage on displacement of the carriage from the outer position to the inner position, the control means operating the drive means to shift the carriage from the outer position to the inner position and then back into the outer position so long as the knob is not in the rest position.

13. The slicing machine defined in claim 11 wherein the knob is movable from the rest position in opposite axial directions into two end positions, machine further comprising
latch means for releasably retaining the knob in one of the end positions against the force of the spring, whereby when the knob is shifted into and latched in the one end position the drive means will be operated continuously while when shifted into the other end position it will return automatically to the rest position and the carriage will stop on returning to the outer position.

14. The slicing machine defined in claim 11 wherein the housing includes a mount centered on the axis and carrying the knob.

15. The slicing machine defined in claim 11, further comprising
means including a setting element immediately adjacent the knob and connected to the control means for varying a cycle time of the carriage.

16. The slicing machine defined in claim 15 wherein the cycle time is varied by varying a pause time between succeeding cycles.

17. The slicing machine defined in claim 15 wherein the cycle time is varied by varying a displacement speed of the carriage.

18. The slicing machine defined in claim 11, further comprising
a motor connected to the blade and energizeable to rotate the blade; and
switch means for energizing the motor in accordance with a position of the knob.
